(19) United States
(12) Patent Application Publication
(10) Pub. No.: US 2003/0077358 A1
(43) Pub. Date: Apr. 24, 2003

(54) Composition

(76) Inventors: Peder Edvard Degn, Ega (DK); Jacob Ailko De Vries, Ega (DK); Merete Faergemand, Ega (DK); Jorn Borch Soe, Tilst (DK)

Correspondence Address: Thomas J. Kowalski, FROMMER LAWRENCE & HAUG LLP, 745 Fifth Avenue, New York, NY, 10151, US

(21) Appl. No.: 10/196,436

(22) Filed: Jul. 15, 2002

Related U.S. Application Data
(60) Provisional application No. 60/343,514, filed on Dec. 21, 2001.

(30) Foreign Application Priority Data
Jul. 16, 2001 (GB) 0117305.3

(51) Int. Cl. A23K 1/00

(52) U.S. Cl. 426/52

(57) ABSTRACT

The present invention provides a composition comprising a hydrocolloid, and an enzyme, wherein the enzyme is a cross-linking enzyme and the hydrocolloid and enzyme are present in an amount to provide a dosage of the enzyme in a protein containing foodstuff of no greater than 20 U/g and a concentration of the hydrocolloid in the foodstuff of less than 1%.

### COMPOSITION

The present invention relates to a composition comprising a hydrocolloid, and an enzyme.

A large number of hydrocolloids have been used for many years as food additives for gelation and stabilisation purposes. For example, carrageenan has been used as a gelling agent in puddings and other desserts as well as for the stabilisation of cocoa particles against sedimentation in cocoa milk. Pectin has been used for providing texture in many products, one of the major uses of pectin is in jams and jellies where pectin provides gel strength. Pectin is also used in other foods, e.g., in fermented milk products for gel strength and to increase viscosity and stabilisation against wheying off. Work on the use of hydrocolloids in food is summarised by e.g. Lapasin and Pricl (1995), Rheology of industrial polysaccharides: Theory and Applications, Chapter 2: Industrial Applications of polysaccharides, Chapman & Hall, London, UK.

Enzymatic cross-linking of proteins is a somewhat newer type of stabilisation mechanism for protein containing food products. Research during the last 10-15 years has shown a number of interesting applications for enzymatic cross-linking. However, so far work related to enzymatic cross-linking has been concerned with the beneficial effects of protein cross-linking as such or in combination with other types of enzymes, e.g. protease.

Enzymatic protein cross-linking is an enzyme catalysed process which directly or indirectly binds proteins or peptides together by chemical bonds. Transglutaminase (TGase) is a group of enzymes with the systematic name R-glutaminyl-peptide:amine γ-glutamyl-transferase. These enzymes catalyse an acyl transfer reaction between the γ-carboxamide group of peptide-bound glutamine residues as acyl donors and various primary amines as acceptors. When the ε-amino group of peptide-bound lysine acts as acyl acceptor, an ε-(γ-glutamyl)lysine cross-link is formed (Folk and Finlayson, 1977, The ε-(γ-Glutamyl)lysine Crosslink and the Catalytic Role of Transglutaminases. Advances in Protein Chemistry 31, 2-120). Furthermore, several oxidative enzymes such as amine oxidase, diamine oxidase and lysyl oxidase have been shown to induce protein cross-linking (Matheis and Whitaker, 1987, A review: enzymatic cross-linking of proteins applicable to foods. Journal of Food Biochemistry 11, 309-327). Generally this happens through the formation of H₂O₂ which induces free radical formation in the proteins (e.g. reactive quinines or aldehydes). Further to these groups of enzymes, some proteases are known to hydrolyse proteins in a specific manner during which peptides are formed that cross-link by hydrophobic interactions (Otte, J., Ju, Z. Y., Færgemand, M., Lomholt, S. B. and Qvist, K. B., 1996, Protease-induced aggregation and gelation of whey proteins. Journal of Food Science 65, 911-915).

Enzymatic cross-linking has been shown to induce gelling, and to affect a variety of functional properties of a wide number of food proteins including milk proteins. Milk gels based on cross-linked proteins have been produced both at acid pH (Budolfsen, G., Nielsen, P. M., 1999, Method for production of an acidified edible gel on milk basis, U.S. Pat. No. 5,866,180) and from not-acidified milk (Budolfsen, G., Nielsen, P. M., 1994, Method for production of a not acidified edible gel on milk basis, and use of such a gel, WO 94/21130). Furthermore, several patents exist on the application of transglutaminase in ice cream (Motoki, M., Atsushi, O., Nonaka, M., Tanaka, H., Uchio, R., Matsuura, A., Ando, H., Umeda, K., 1992, Transglutaminase, U.S. Pat. No. 5,156,956; Yuzo, O., Kazuyoshi, M., Takahiko, S., 1993, Method for producing low-calorie ice creams, JP 5091840A2; Hirobumi, M., Isao, K., 1994, Method for improving quality of ice cream, JP 6303912A2.; Takahiko, S., Katsutoshi, Y., 1995, Production of ice creams, JP 7184554A2).

WO 99/29186 concerns a method for accelerating the digestion rate of a protein matter which consists in treating the protein matter with transglutaminase, and mixing it with anionic polysaccharides.

U.S. Pat. No. 5,156,956 concerns a process for producing a protein gelation product, which comprises contacting a protein-containing solution or slurry with a transglutaminase which catalyses an acyl transfer reaction of a γ-carboxyamide group of a glutamine residue in a peptide or protein chain independently of Ca²⁺. The composition may additionally comprise a polysaccharide.

The present invention alleviates the problems of the prior art.

In one aspect the present invention provides a composition comprising a hydrocolloid, and an enzyme, wherein the enzyme is a cross-linking enzyme and the hydrocolloid and enzyme are present in an amount to provide a dosage of the enzyme in a protein containing foodstuff of no greater than 20 U/g and a concentration of the hydrocolloid in the foodstuff of less than 1%.

In one aspect the present invention provides a composition comprising a hydrocolloid, a protein and an enzyme, wherein the enzyme is a cross-linking enzyme and the dosage of the enzyme is no greater than 20 U/g of protein and the concentration of hydrocolloid is less than 1%.

In one aspect the present invention provides a protein-containing beverage comprising a composition as defined herein and a milk protein.

In one aspect the present invention provides a process for the preparation of a composition comprising a cross-linked protein, the process comprising the steps of contacting a protein with a hydrocolloid and an enzyme; wherein the enzyme is a cross-linking enzyme, the dosage of the enzyme is no greater than 20 U/g and the concentration of hydrocolloid is less than 1%.

In one aspect the present invention provides a use of a hydrocolloid and a cross-linking enzyme for the synergistic formation of a gel in a protein containing foodstuff.

By the term “synergistic formation” it is meant the formation of a gel having a higher complex modulus (gel stiffness) and/or lower phase angle (as described herein) than would be predicted from a simple additive effect of a hydrocolloid and a cross-linking enzyme.

In one aspect the present invention provides a use of a composition comprising a hydrocolloid, a protein and a cross-linking enzyme in the preparation of foodstuff selected a dessert, an acidified gel, a drinkable protein-containing beverage, and a dough

In one aspect the present invention provides a use of a composition comprising a hydrocolloid, and a cross-linking enzyme in the preparation of a protein containing ice cream wherein said enzyme is in a dosage no greater than 20 U/g.

It has been surprisingly found that there is a synergy between added hydrocolloids and enzymatic cross-linking in protein containing foods.

It has been found that the use of hydrocolloids in combination with enzymatic cross-linking of protein gives surprisingly strong gelation in compositions (foods or parts of foods) containing proteins and hydrocolloids, and in which the use of either alone gives much weaker gelation.

In one aspect the present invention provides use of a hydrocolloid and a cross-linking enzyme for the synergistic formation of a gel in a protein containing cosmetic.

It has been surprisingly found that there is a synergy between added hydrocolloids and enzymatic cross-linking in protein containing cosmetics.

It has been found that the use of hydrocolloids in combination with enzymatic cross-linking of protein gives surprisingly strong gelation in compositions (cosmetics or parts of cosmetics) containing proteins and hydrocolloids, and in which the use of either alone gives much weaker gelation.

As used herein, the term “protein” is equivalent to the term “polypeptide” or “proteinaceous”.

By the term “cross-linking enzyme” it is meant that the enzyme catalyses the cross-linking directly or indirectly of a protein or proteins. Examples of protein cross-linking enzymes includes transferases such as transglutaminases, oxidoreductases and some proteases.

As used herein, the term “hydrocolloid” refers to molecules or polymolecular particles which are dispersed/dispersible in water or an aqueous solution. Hydrocolloids may comprise polysaccharides. Hydrocolloids do not pass or pass slowly through semi-permeable membranes. Examples of hydrocolloids include carrageenan, starch, pectin, guar gum, alginate, locust bean gum (LBG), gellan, xanthan, carboxy-methyl-cellulose (CMC), guar gum, acacia gum.

In one aspect the hydrocolloid is other than the protein which is to be or has been cross-linked.

Preferred Aspects

Enzymes

In a preferred aspect the enzyme is transglutaminase (TGase).

In one aspect preferably the dosage of enzyme is no greater than 20 U/g, preferably no greater than 18 U/g, preferably no greater than 16 U/g, preferably no greater than 14 U/g, preferably no greater than 12 U/g, preferably no greater than 10 U/g, preferably no greater than 6.25 U/g, preferably no greater than 4 U/g, preferably no greater than 3.5 U/g, preferably no greater than 2 U/g, preferably no greater than 1.6 U/g, preferably no greater than 1.3 U/g, preferably no greater than 0.5 U/g, preferably no greater than 0.3 U/g, preferably no greater than 0.15 U/g.

Enzyme activity is determined by the hydroxamate procedure with CBZ-L-glutaminylglycine as substrate (Folk and Cole, 1966, Mechanism of action of guinea pig liver transglutaminase, J. Biol. Chem. 241, 5518-5525). As used herein, the enzyme activity “unit (U)” is defined as one unit causing the formation of 1 M (mole) of hydroxamic acid/minute at pH 6.0 and 37° C. U/g refers to enzyme activity per gram of substrate protein.

The specific activity of the enzyme preparation may be 100 U/g (enzyme activity per gram of product).

The specific activity of the enzyme preparation may be 100 U/g (enzyme activity per gram of product).

Hydrocolloids

In a preferred aspect the hydrocolloid is selected from carrageenan, starch, pectin, alginate, locust bean gum (LBG), gellan, xanthan, CMC, guar gum, acacia gum and combinations thereof.

In one aspect preferably the concentration of hydrocolloid is less than 1%, preferably no greater than 0.95%, preferably no greater than 0.8%, preferably no greater than 0.65%, preferably no greater than 0.6%, preferably no greater than 0.55%, preferably no greater than 0.5%, preferably no greater than 0.45%, preferably no greater than 0.4%.

All percentages given herein are based on the weight of the total food item unless otherwise stated.

In one aspect preferably the concentration of hydrocolloid is no greater than 0.35%, preferably no greater than 0.3%, preferably no greater than 0.25%, preferably no greater than 0.2%.

In one aspect preferably the concentration of hydrocolloid is no greater than 0.15%, preferably no greater than 0.1%, preferably no greater than 0.02%.

In some aspects preferably

the concentration of hydrocolloid is no greater than 0.3% and the concentration of the enzyme is no greater than 10 U/g

the concentration of hydrocolloid is no greater than 0.25% and the concentration of enzyme is no greater than 6.25 U/g

the concentration of hydrocolloid is no greater than 0.2% and the concentration of enzyme is no greater than 2 U/g

Protein

In a preferred aspect the protein is selected from soy protein, milk protein, whey protein, flour protein, meat proteins, and combinations thereof or is present in, obtained from or is obtainable from meat, meat pastes, and protein-containing beverages.

In one aspect preferably the dosage of protein is no greater than 90%, preferably no greater than 75%, preferably no greater than 50%, preferably no greater than 25%.

In one aspect preferably the dosage of protein is no greater than 12%, preferably no greater than 10%, preferably no greater than 9%, preferably no greater than 8%, preferably no greater than 7.5%, preferably no greater than 5%, preferably no greater than 2.5%, preferably no greater than 2%.

Preferably the protein is a soy protein. In this aspect preferably

the hydrocolloid is carrageenan

preferably the concentration of carrageenan is no greater than 0.5%

preferably the concentration of carrageenan is no greater than 0.45%

preferably the concentration of carrageenan is no greater than 0.4%

preferably the concentration of carrageenan is no greater than 0.3%

preferably the concentration of carrageenan is no greater than 0.2%

preferably the carrageenan is contacted with the soy protein before the enzyme is contacted with the soy protein.

the hydrocolloid is starch

preferably the concentration of starch is no greater than 0.5%

preferably the concentration of starch is no greater than 0.45%

preferably the concentration of starch is no greater than 0.4%

preferably the concentration of starch is no greater than 0.2%

preferably the starch and enzyme are contacted with the milk protein simultaneously

preferably the enzyme is contacted with the soy protein before the starch is contacted with the soy protein.

hydrocolloid is pectin

preferably the concentration of pectin is less than 1%

preferably the concentration of pectin is no greater than 0.5%

preferably the concentration of pectin is no greater than 0.2%.

preferably the enzyme is contacted with the soy protein before the pectin is contacted with the soy protein

preferably the pectin is contacted with the soy protein, followed by heat treatment of the mix (for example, 80° C. for 15 min) before the enzyme is contacted with the soy protein

Preferably the protein is a milk protein. In this aspect preferably

the hydrocolloid is carrageenan

preferably the carrageenan and enzyme are contacted with the milk protein simultaneously

preferably the carrageenan is contacted with the milk protein before the enzyme is contacted with the milk protein.

the hydrocolloid is starch

preferably the starch is contacted with the milk protein followed by heat treatment (for example, 80° C. for 15 min) of the mix before the enzyme is contacted with the milk protein

preferably the starch and the enzyme are contacted with the milk protein simultaneously

the hydrocolloid is pectin

preferably the concentration of pectin is less than 1% and the concentration of the enzyme is no greater than 10 U/g

preferably the concentration of pectin is no greater than 0.5%

preferably the concentration of pectin is no greater than 0.2%

preferably the concentration of enzyme is no greater than 5 U/g

preferably the concentration of enzyme is no greater than 2 U/g

Preferably the protein is a whey protein. In this aspect preferably

the hydrocolloid is carrageenan.

preferably the enzyme is contacted with the whey milk protein before the starch is contacted with the whey protein.

the hydrocolloid is starch

preferably the enzyme is contacted with the whey milk protein before the starch is contacted with the whey protein.

Preferably the protein is present in, obtained from or is obtainable from a protein-containing beverage. In this aspect preferably

the hydrocolloid is carrageenan

preferably the concentration of carrageenan is no greater than 0.04% and the dosage of enzyme is no greater than 10 U/g

preferably the concentration of carrageenan is no greater than 0.02%

preferably the concentration of carrageenan is no greater than 2 U/g

preferably the dosage of enzyme is no greater than 1.6 U/g

preferably the dosage of enzyme is no greater than 1.3 U/g

preferably the composition further comprises a flavouring

preferably the flavouring is cocoa solids

preferably the flavouring is selected from chocolate, strawberry, raspberry, banana, orange, mango, lemon, lime, cherry, peach, pear, apple, pineapple or combinations thereof

As used herein the phrase “protein-containing beverage” refers to a protein in solution. For example, milk, soy milk and recombined milk; recombined milk is commonly made from dried milk powder, (anhydrous) milk fat and water

Preferably the protein is a gluten. In this aspect preferably

the hydrocolloid is guar gum

the dosage of enzyme is no greater than 0.3 U/g

the dosage of enzyme is no greater than 0.15 U/g

Process

In the process of the present invention, the enzyme, the protein and hydrocolloid may be provided separately or in combination thereof. In the aspect that they are provided together preferably the hydrocolloid and the enzyme are provided as a composition as defined herein.

The enzyme and hydrocolloid may be contacted with the protein in any order. They may be contacted with the protein at the same time, the enzyme may be contacted with the protein first and the hydrocolloid subsequently or the hydrocolloid may be contacted with the protein first and the enzyme subsequently. In some aspects the amount of hydrocolloid and/or enzyme may be split and the contact may be a combination of the above.

Further Aspects

In further aspects the present invention provides

Use of a hydrocolloid and a cross-linking enzyme for the synergistic formation of a gel in a protein containing foodstuff.

Use of a hydrocolloid and a cross-linking enzyme in the preparation of a dessert.

Use of a hydrocolloid and a cross-linking enzyme in the preparation of a yoghurt or an acidified dessert product (acidified gel).

Use of a hydrocolloid and a cross-linking enzyme in the preparation of a protein-containing beverage for example, a cocoa milk drink, a drinkable yoghurt, a whey-based drink.

Use of a composition as defined herein in the preparation of ice cream.

in this aspect preferably the hydrocolloid is carrageenan and the enzyme is TGase

Use of a hydrocolloid and a cross-linking enzyme in the preparation of a baked product.

in this aspect preferably the hydrocolloid is guar and the enzyme is TGase

Use of a hydrocolloid and a cross-linking enzyme in the preparation of a dough.

In this aspect preferably the hydrocolloid is Guar gum and the enzyme is TGase

Use of a hydrocolloid and a cross-linking enzyme in the preparation of a meat product.

Use of a hydrocolloid and a cross-linking enzyme for synergistic formation of a gel in a protein containing cosmetic.

As used herein the phrase “acidified dessert product” is equivalent with the term “acidified gel” and/or the term “yoghurt”

The present invention will now be described in further detail by way of example only with reference to the accompanying figures in which:

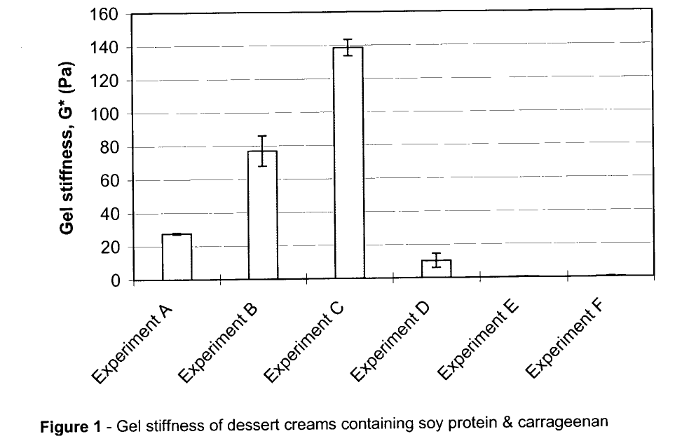

FIG. 1 Shows the gel stiffness of dessert creams containing soy protein & carrageenan

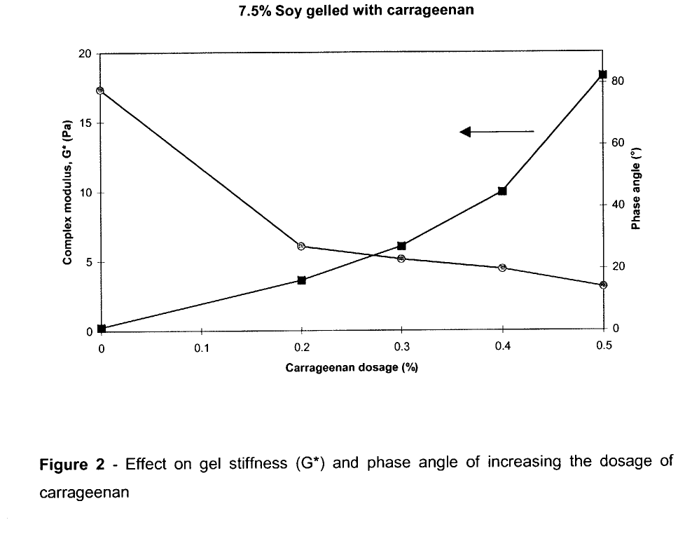

FIG. 2 Shows the effect on gel stiffness (G*) and phase angle of increasing the dosage of carrageenan

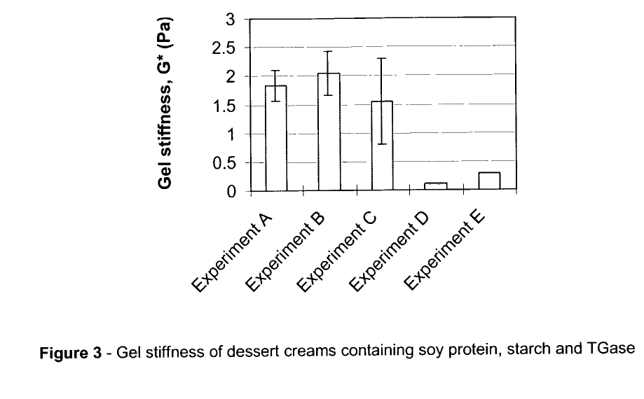

FIG. 3 Shows the gel stiffness of dessert creams containing soy protein, starch and TGase

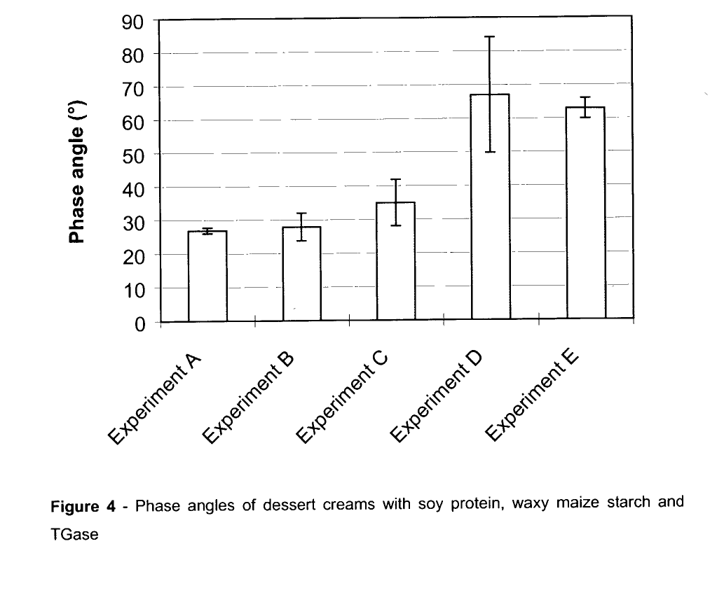

FIG. 4 Shows the phase angles of dessert creams with soy protein, waxy maize starch and TGase

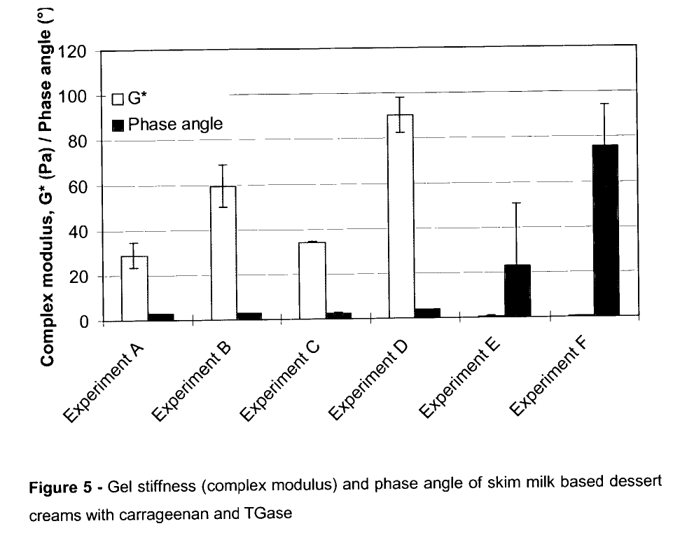

FIG. 5 Shows the gel stiffness (complex modulus) and phase angle of skim milk based dessert creams with carrageenan and TGase

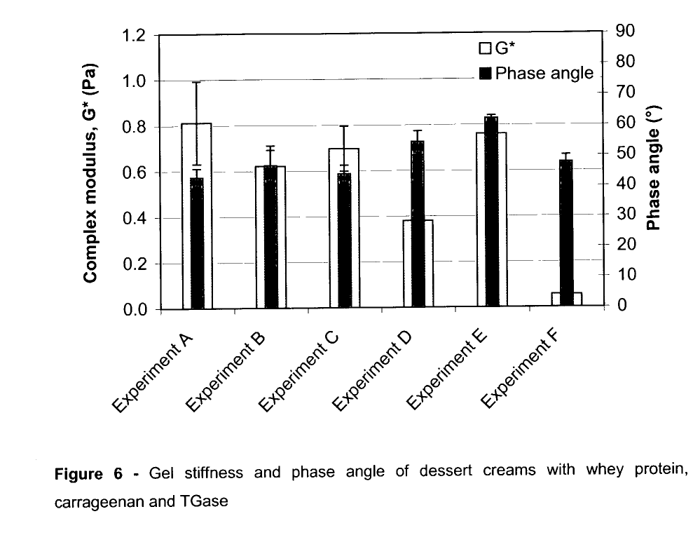

FIG. 6 Shows the gel stiffness and phase angle of dessert creams with whey protein, carrageenan and TGase

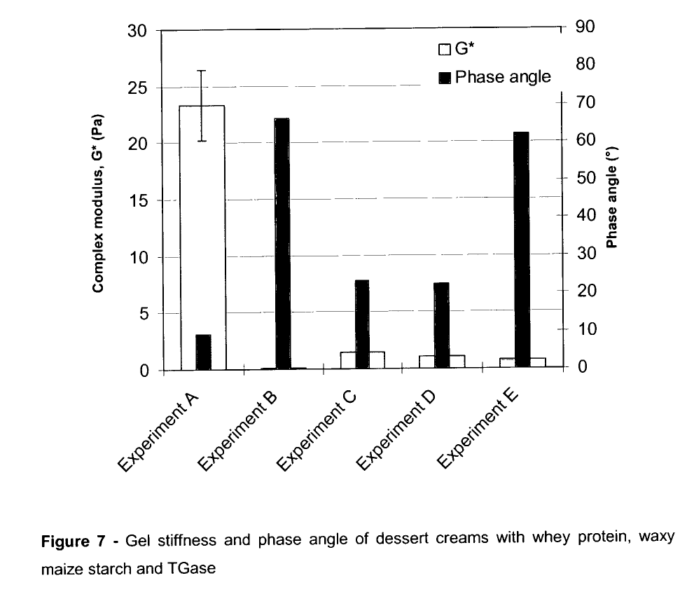

FIG. 7 Shows the gel stiffness and phase angle of dessert creams with whey protein, waxy maize starch and TGase

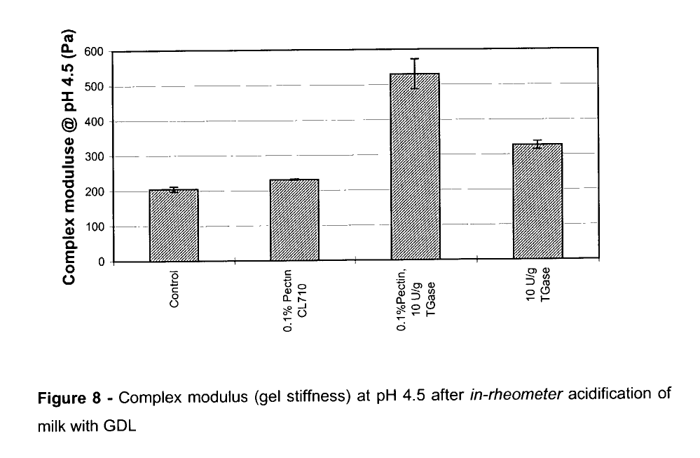

FIG. 8 Shows the complex modulus (gel stiffness) at pH 4.5 after in-rheometer acidification of milk with GDL (glucono-delta-lactone)

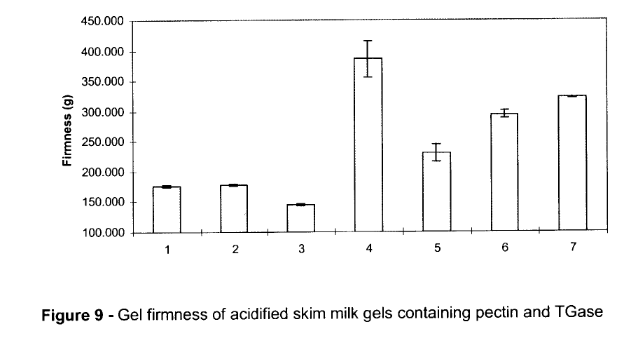

FIG. 9 Shows the gel firmness of acidified skim milk gels containing pectin and TGase

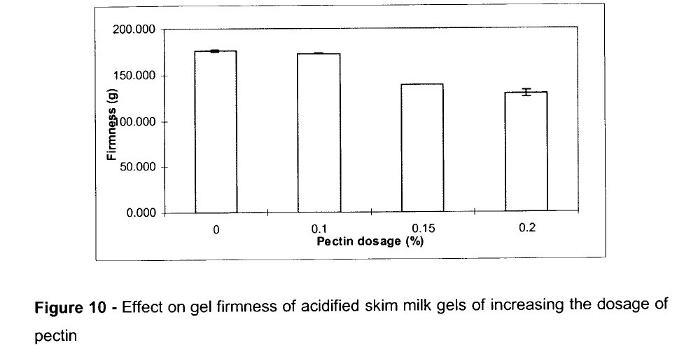

FIG. 10 Shows the effect on gel firmness of acidified skim milk gels of increasing the dosage of pectin

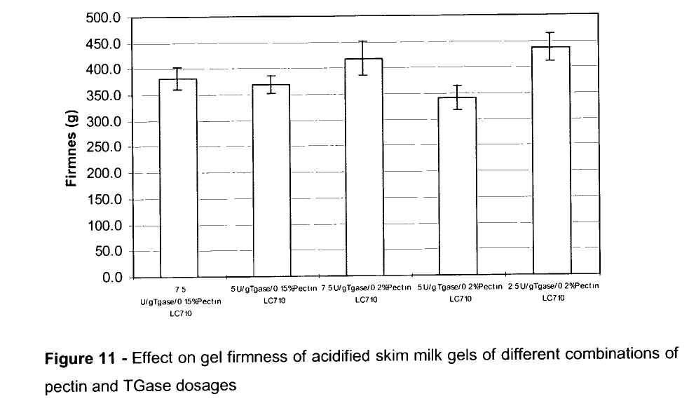

FIG. 11 Shows the effect on gel firmness of acidified skim milk gels of different combinations of pectin and TGase dosages

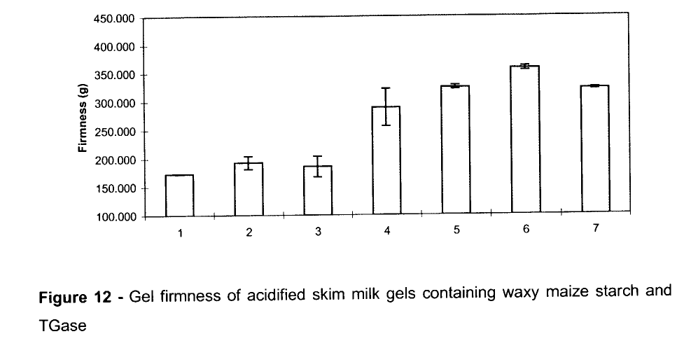

FIG. 12 Shows the gel firmness of acidified skim milk gels containing waxy maize starch and TGase

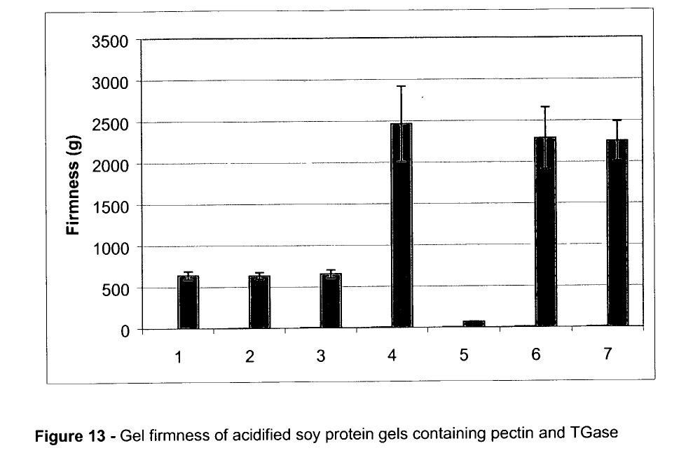

FIG. 13 Shows the gel firmness of acidified soy protein gels containing pectin and TGase

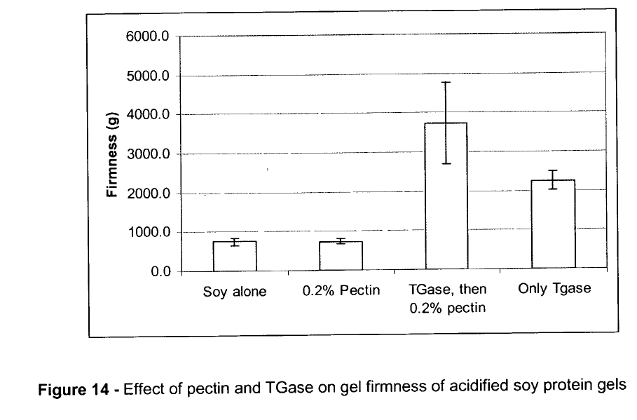

FIG. 14 Shows the effect of pectin and TGase on gel firmness of acidified soy protein gels

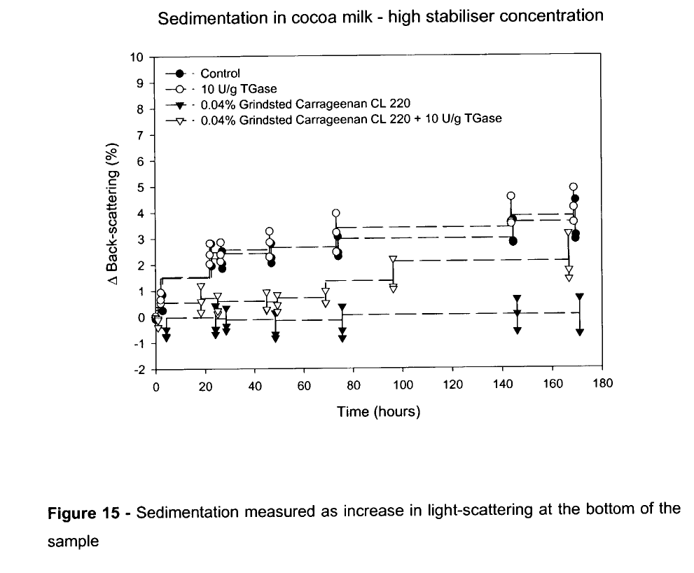

FIG. 15 Shows the sedimentation measured as increase in light-scattering at the bottom of the sample

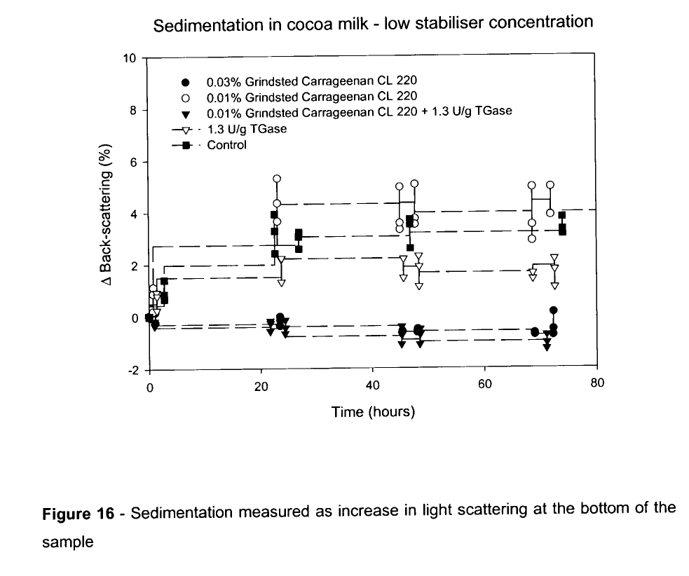

FIG. 16 Shows the sedimentation measured as increase in light scattering at the bottom of the sample

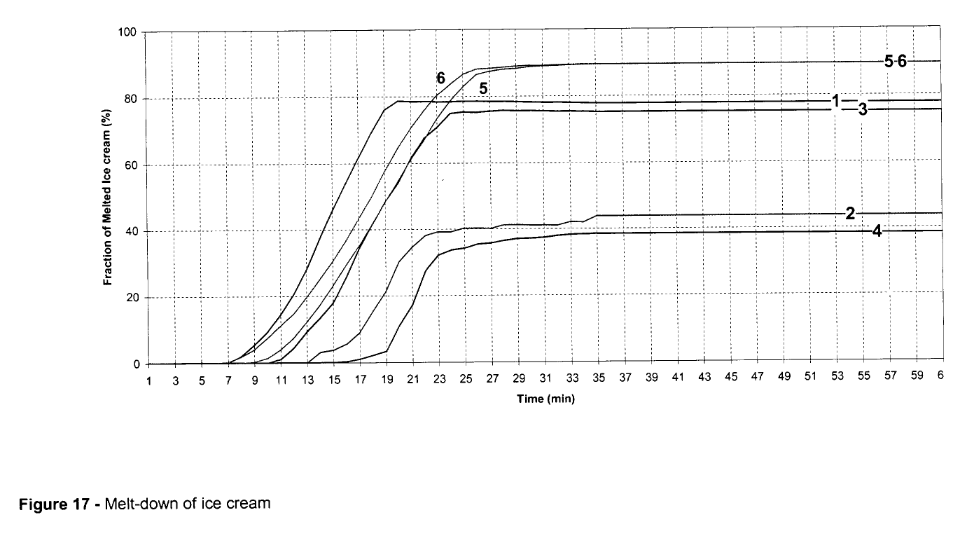

FIG. 17 Shows the melt-down of ice cream

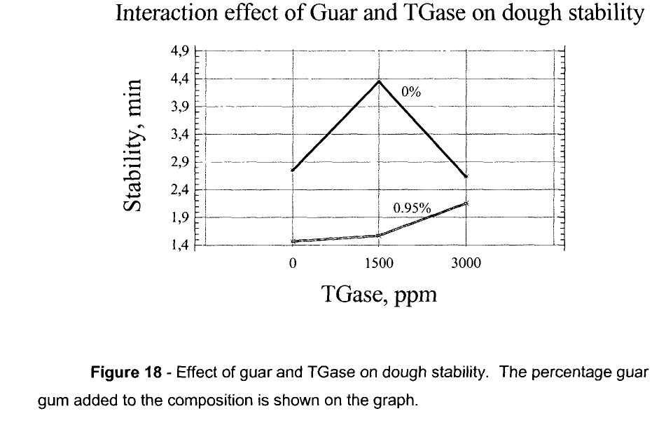

FIG. 18 Shows the effect of guar and TGase on dough stability. The percentage guar gum added to the composition is shown on the graph.

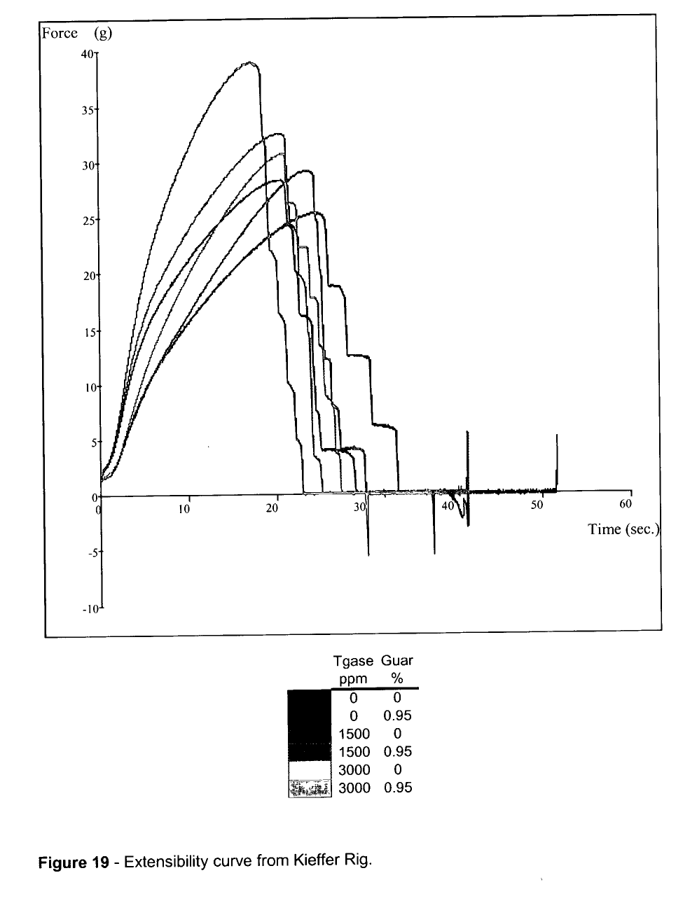

FIG. 19 Shows the extensibility curve from Kieffer Rig

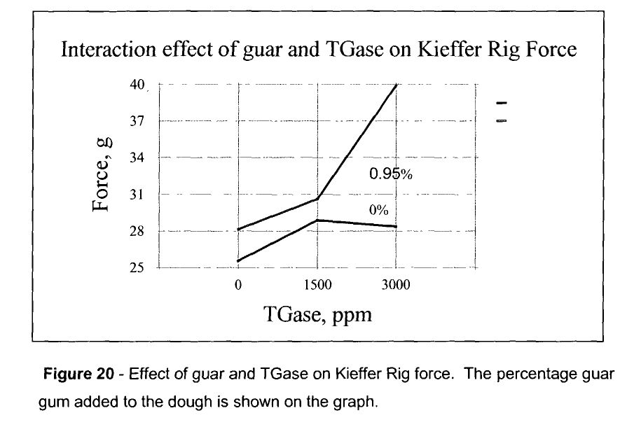

FIG. 20 Shows the effect of guar and TGase on Kieffer Rig force. The percentage guar gum added to the dough is shown on the graph.

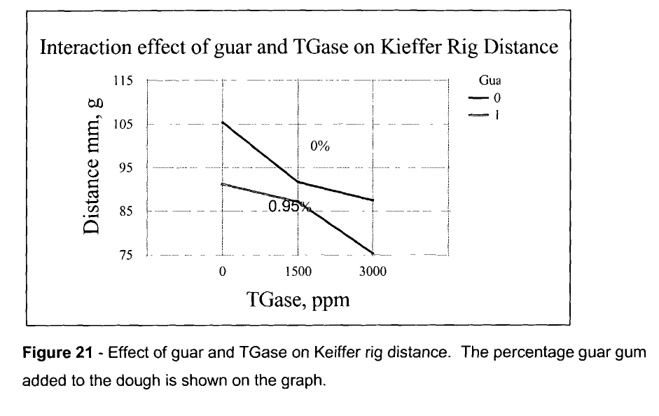

FIG. 21 Shows the effect of guar and TGase on Keiffer rig distance. The percentage guar gum added to the dough is shown on the graph.

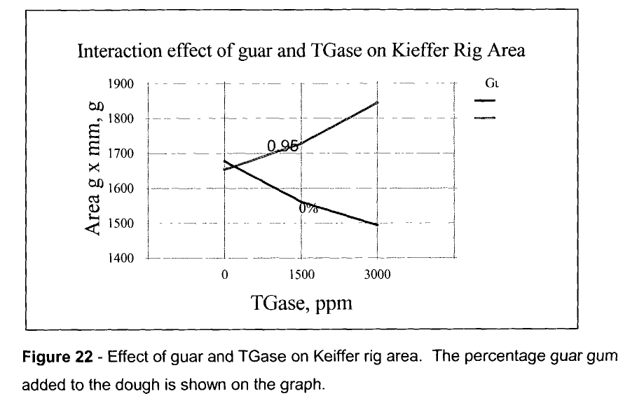

FIG. 22 Shows the effect of guar and TGase on Keiffer rig area. The percentage guar gum added to the dough is shown on the graph.

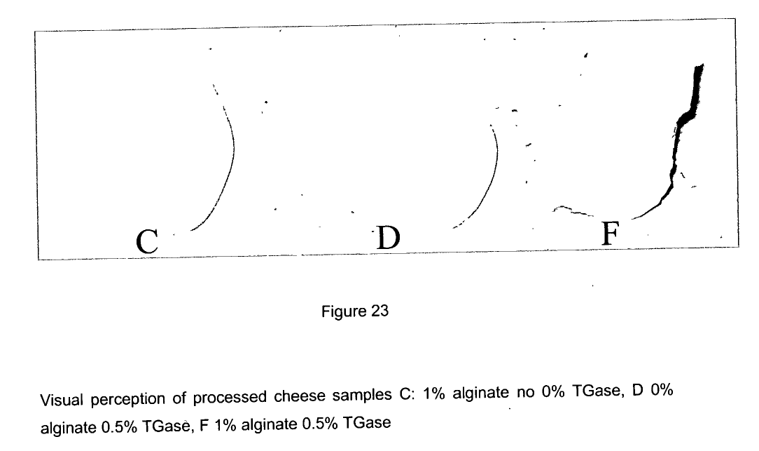

FIG. 23 Shows processed cheese samples containing combinations of alginate and/or Tgase

In all figures when error bars are shown the values shown are averages of duplicate experiments—error bars indicate the standard deviation—unless otherwise described.

The present invention will now be described in further detail in the following examples.

### EXAMPLES

Materials & Methods

The enzyme preparation used in the following examples was Ajinomoto Active VM (Ajinomoto, Japan) with a declared activity of 100 u/g.

The concept of synergy between hydrocolloids and enzymatic cross-linking was tested in five systems (1) a dessert model system, (2) an acidified milk system, (3) a cocoa milk model, (4) an ice cream system and (5) a dough system.

In each system the order of addition and simultaneous addition of the enzyme and the hydrocolloid was tested without changing other parameters. Furthermore, in some systems, experiments were performed where one or both of the enzyme and/or hydrocolloid were omitted from the product.

Dessert Model System.

The basic recipe of this model is given below:

37.5 g of soy isolate (Supro XT 12) was dissolved in 453.5 g demineralised water at 60° C. for 30 min under stirring. Then cooled to 40° C.

To 50 ml of the above mixture 10 U/g TGase (Active WM, 100 Units/g, Ajinomoto Co.) was added and the mixture incubated at 40° C. for 60 min.

0.1 g carrageenan (Grindsted™ Carrageenan CL 360) mixed with 0.5 g sugar was added under agitation to the above mentioned mixture.

This final mix was heated to 80° C. and kept at 80° C. for 10 minutes.

After these 10 minutes the final mix was transferred to a StressTech controlled stress rheometer, where the gelation during cooling from 80° C.-5° C. at 1° C./min was followed.

The temperature was then kept at 5° C. for 60 min in order to measure the gel build up.

Set-up for measurements on StressTech rheometer

| | |
|---|---|
| Measurement type: | Strain controlled oscillation |
| Measuring system: | C25, concentric cylinder |
| Strain: | 0.005 |
| Frequency: | 1 Hz |
| Temperature: | 80-5° C., 1° C./min − 60 min 5° C. constant |
| Initial equilibrium time: | 300 s |

The following parameters were extracted from the rheological measurements:

G*: complex modulus or gel stiffness (Pa); this is a measure of the total resistance of the sample to small deformations.

Phase angle, δ: The phase angle describes whether the sample is mainly solid (elastic) or liquid (viscous). A perfectly elastic sample has a phase angle of 0°, whereas a perfectly viscous fluid (e.g. water) has a phase angle of 90°. Preferably the phase angle is 450 or less

Other dessert models were tested where soy (7.5% protein in these experiments) was exchanged with whey protein isolate (5% protein) or Skim milk powder (3% protein). In all experiments the level of enzyme was kept constant at the same level as described in the example above, whereas the carrageenan concentration (of the total product) was kept constant in all experiments.

Other dessert models (based on soy, whey or skim milk) were tested where carrageenan was exchanged with starch (Waxy maize, 1%).

Acidified Gelled Product (e.g. Yoghurt Model)

The basic recipe of this model is given below:

Skim milk was heated to 80° C. for 15 minutes. Then cooled to 40° C.

10 U/g TGase (Ajinomoto) was added and the sample was incubated at 40° C. for 60 minutes

0.1% GRINDSTED® Pectin LC 710 was dry blended with 0.5 g sugar and added to the milk mix under agitation for 15 minutes

2% glucono-delta-lactone (GDL) was added and the sample was incubated at 40° C. for acidification. When the pH dropped to 4.5 the samples was cooled and stored overnight at 5° C. before measurements.

In some experiments the gelation of the acidified milk product was followed on a StressTech rheometer, where the sample was applied after adding GDL. The pH drop was followed in a parallel sample and the rheological measurement was stopped at pH 4.5.

Set-up for measurements on StressTech rheometer:

| | |
|---|---|
| Measurement type: | Strain controlled oscillation |
| Measuring system: | C25, concentric cylinder |
| Strain: | 0.005 |
| Frequency: | 1 Hz |
| Temperature: | 40° C. constant |
| Initial equilibrium time: | 300 s |

In other experiments, the large deformation properties of the acidified gel was determined after overnight storage at 5° C. using a Texture Analyser to measure the resistance of the sample to back-extrusion.

Set-up for measurements on Texture Analyser:

| | |
|---|---|
| Test mode: | Measure force in compression |
| Probe: | Back extrusion rig 35 mm |
| Test speed: | 1 mm/s |
| Temperature: | Room/25° C. |
| Load cell: | 5 kg |
| Distance: | 20 mm |
| Trigger: | Auto, 10 g |

Samples were also prepared where pectin (0.1%) was replaced with starch (0.5%).

Protein-Containing Beverage Model—Cocoa Milk

A cocoa milk model was prepared from the basic recipe below:

37.5 g of skim milk powder, 30 g of sugar and 10 g of defatted cocoa powder was dissolved in 420 g of demineralised water at 60° C. for 30 minutes under stirring. Then cooled to 40° C.

To 50 ml of the above mixture 10 U/g TGase (Active WM, 100 Units/g, Ajinomoto Co.) was added and the mixture incubated at 40° C. for 60 minutes

0.02 g carrageenan (GRINDSTED® Carrageenan CL 220) mixed with 0.10 g sugar was added under agitation to the above mentioned mixture.

this mix was heated to 80° C. for 15 minutes

The cocoa milk was pipetted into Turbiscan test tubes after cooling to room temperature and the stability (sedimentation or clearing) was followed during storage of the cocoa milk at 5° C.

In some experiments skim milk protein was replaced with soy isolate.

Sedimentation was followed during storage by measuring the back-scattering at the bottom using a Turbiscan instrument (Formulation, France). The back-scattering is a measure of the particle density (or size) in the specific layer of the sample (i.e. in this case at the bottom). Sedimentation will increase the back-scattering at the bottom of the samples, as the particle density increases.

Ice Cream Model

An ice cream model was prepared by the basic recipe below.

| | | |
|---|---|---|
| Water | 61.778% | |
| Hardened coconut oil (Cocowar 31) | 7.888% | |
| Skim milk powder | 11.173% | |
| Sucrose | 14.000% | |
| Glucose syrup | 4.211% | |
| CREMODAN ® SE 30* | 0.6% | |
| Vanilla Flavouring NA U35035 | 0.300% | |
| Colour, a-160-ws | 0.05% | |
| In some experiments: | | |
| CREMODAN ® SUPER* | 0.3% | |
| GRINDSTED ® Carrageenan IC F | 0.05% | |
| TGase (Activa MP) | 0.25% | (i.e. 6.25 U/g protein) |

In some experiments CREMODAN ® SUPER (0.3%) and GRINDSTED ® Carrageenan IC F (0.05%) and/or TGase (0.25%) is used instead of the standard emulsifier/stabilizer blend (CREMODAN ® SE 30). In some cases TGase is added together with the standard emulsifier/stabilizer blend (CREMODAN ® SE 30).
*CREMODAN ® SE 30 is an integrated blend of food grade emulsifiers (Mono and Diglycerides) and stabilizers (Carrageenan, LBG, Sodium Alginate, Guar Gum).
*CREMODAN ® SUPER is a Mono-Diglyceride made from edible fully hydrogenated vegetable fat.

Process:

1. Melt the fat at approx. 50° C.

2. Mix the liquid ingredients at 20-22° C.

3. Mix the dry ingredients

4. Add Vanilla Flavouring

5. Add Colouring

6. Add the fat and increase temperature to 30° C.

7. Pasteurise at 78° C. for 2-3 minutes

8. Homogenise at 78° C., optimum pressure based on fat percentage

9. Cool to 40° C. at homogeniser cooler

10. Add TGase and leave for 45 min at 40° C.

11. Cool to 5° C. in ice water bath

12. Age overnight in ice water (1-2° C.)

13. Stir

14. Freeze in continous freezing tunnel at −2.8° C. with 60% overrun

15. Fill a 1-liter cup

16. Fill in moulds and freeze with sticks inserted

17. Freeze overnight at −30° C. in a hardening tunnel

18. Store at −18° C.

The melt down of the ice cream is assessed by application of the ice cream on a net in controlled temperature (20° C.) and measuring how much melted ice drips through the net.

Dough Model System

The dough is prepared by the basic recipe below.

| | |
|---|---|
| Flour | 10.0 g |
| Salt | 0.2 g |
| Water | 500 Brabender Unit (BU) |
| | (BU was determined according to the AACC |
| | method 54-21) |
| + enzyme and guar | |

The Theological effects of the dough are studied by Farinograph tests followed by Extensiograph measurement using a Texture Analyser with a Kieffer Rig.

The dough is mixed for 6 minutes at 26° C. on a Farinograph. (The Farinograph curve is analysed according to AACC method and stability and dough development time is recorded.)

Plastic strips are placed onto the grooved base of the form. 15 g of dough sample (ready prepared) is placed onto the grooved base of the form. The top block of the form is placed onto the sample and push down firmly until the two blocks come together. Excess dough is removed from sides. The form containing the dough is clamped in the form press for 40 minutes at 34° C. in plastic bags; this cuts the sample into strips, allows the dough to relax and prevents loss of moisture. The dough form is then removed from the press and the dough strips are uncovered one by one when required, by carefully sliding the top form block over the grooved base.

Test Set-Up: Carefully remove each plastic strip with dough with a spatula, taking care not to penetrate, stretch or deform the dough. Place the strip onto the grooved region of the sample plate and, holding down the spring loaded clamp lever, insert the plate into the rig. The tensile test on the Texture Analyser is then commenced.

Sample Results: Test results obtained from approximately 8 dough samples (of the same preparation) give the mean peak force (g) and distance values(mm) (at the extension limit points), along with their respective coefficients of variation (C.V.): The integrated area of force×distance (g×mm) is also calculated.

### Examples 1 to 3

### Dessert Models

### Example 1

### Soy Protein Systems

### Example 1.1

### Soy, Carrageenan & TGase

Experiments were performed measuring the gel stiffness of dessert creams containing soy protein, 0.3% carrageenan, 10 U/g TGase per substrate protein.

The experiments performed were

A: TGase added first, carrageenan after 1 hr

B: TGase and carrageenan added together

C: Carrageenan added first, then enzyme

D: Only carrageenan added

E: Only TGase added

F: Control.

In the soy based dessert model product a clear synergy between carrageenan and enzymatic cross-linking was observed. FIG. 1 shows the results of experiments where the order of addition was varied. It is clear that the highest degree of synergy was obtained when carrageenan was allowed to react with soy protein before the addition of the cross-linking enzyme (Experiment C). When the cross-linking enzyme was added prior to carrageenan the gel stiffness obtained was about 5 times lower than when the ingredients were added in the reverse order. This indicates that the mechanism providing the very high gel stiffness when using a cross-linking enzyme and carrageenan is the cross-linking of a protein-hydrocolloid network—probably because the reaction of carrageenan with soy protein results in much larger particles which can then easily form a network when a cross-linking enzyme is added.

For comparison the effect of increasing the dosage of carrageenan is shown in FIG. 2

### Example 1.2

### Soy, Waxy Maize Starch & TGase

Example 1.1 was repeated. In place of carrageenan, starch (another ingredient used in many food products) was used.

The experiments performed were

A: TGase added first, starch after 1 hr

B: TGase and starch added together

C: Starch added first, then enzyme

D: Only starch added

E: Only TGase added

A beneficial effect of adding the starch in combination with a cross-linking enzyme was found—see FIG. 3. Clearly, a synergy between the enzyme and starch exists as well. Contrary to the experiments with carrageenan and cross-linking enzyme, there was no clear effect of the order of addition for starch. Probably, the reason for this is a less specific reaction between starch and protein than between carrageenan and protein. However, the synergy between adding starch and a cross-linking enzyme was clear; particularly from the phase angles—see FIG. 4. Neither of the ingredients formed gels when added alone (in this dosage). However, when added together, a phase angle lower than 45° indicated gel formation.

As opposed to the case with carrageenan, the interaction between soy protein, starch and cross-linking enzyme seems slightly favoured (lower phase angle, see FIG. 4) by adding TGase first and then starch. Possibly the swelling (enzymatically and with regard to protein network formation) of the inert starch granules sterically hinder some cross-linking when starch is added before the cross-linking reaction takes place.

### Example 2

### Milk Protein Systems

### Example 2.1

### Milk, Carrageenan & TGase

Experiments were performed measuring the gel stiffness (complex modulus) and phase angle of skim milk based dessert creams containing carrageenan and TGase. The experiments were:

A: TGase added first, carrageenan after 1 hour

B: TGase and carrageenan added together

C: Carrageenan added first, then enzyme

D: Only carrageenan added

E: Only TGase added

F: Control.

In the unique micellar protein system of milk the effect of adding a cross-linking enzyme together with carrageenan was less obvious—see FIG. 5.

No positive effect was observed on gel stiffness when adding the two in combination; the highest gel stiffness was obtained by carrageenan alone.

A synergistic effect was observed on the phase angle (degree of elasticity), where addition of the cross-linking enzyme decreased the phase angle slightly (especially when added after carrageenan; experiment C), thus forming a more elastic gel, but with lower total gel stiffness. Possibly, the negative influence on gel stiffness of cross-linking in this system is due to the formation of a coarser network. Even a few cross-links between casein micelles may create very large particles that may interrupt the particle network. Thus, a ruptured network, but with strong strands, may be formed.

### Example 3

### Whey Protein Systems

### Example 3.1

### Whey, Carrageenan & TGase

Experiments were performed measuring the gel stiffness of a whey protein based dessert model (5% protein) containing carrageenan and TGase.

The experiments performed were:

A: TGase added first, carrageenan after 1 hr

B: TGase and carrageenan added together

C: Carrageenan added first, then enzyme

D: Only carrageenan added

E: Only TGase added

F: Control.

Carrageenan alone did not induce gelation (i.e. the phase angle was higher than 45°), but increased the viscosity (viscous modulus, not shown) of the solution, as shown by an increase in the complex modulus (which is a sum of the elastic and viscous moduli)—see FIG. 6. Cross-linking enzyme alone has a similar effect (increased viscous modulus (not shown) but high phase angle).

When carrageenan and cross-linking enzyme were both added, gelation was found and the total gel stiffness was much increased compared to adding only carrageenan (about doubled). Thus, when adding either of the ingredients alone an increase in total stiffness (complex modulus) was found due to an increase in the viscous modulus. However, when both ingredients were added, both a gel formation and increased gel stiffness occurred compared to the control. Thus, a synergy between adding the two ingredients exists.

### Example 3.2

### Whey, Starch & TGase

Experiments were performed measuring gel stiffness of a whey protein based dessert model (5% protein) containing waxy maize starch and TGase.

The experiments performed were:

A: TGase added first, starch after 1 hr

B: TGase and starch added together

C: Starch added first, then enzyme

D: Only starch added

E: Only TGase added.

With starch in a whey based dessert model product, a fantastic synergy was found—see FIG. 7. When reacting the cross-linking enzyme with whey protein prior to adding the starch (at 80° C.), a 20 times increase in gel stiffness was found compared to when using starch or cross-linking enzyme alone (Experiment A). A clearly stronger gel was formed, indicated by a reduction of the phase angle from about 22° (starch) or 62° (enzyme alone) to 9° when using the combination. The synergy was observed in particular when the starch was added at 80° C. after the cross-linking of the whey protein (the advantage of adding TGase before starch was also, though to a smaller extent, observed in a soy based system—see FIG. 4).

### Examples 4 to 5

### Acidified Gels

Experiments were performed measuring the gel firmness of a milk protein/soy protein based dessert model containing a hydrocolloid and TGase.

### Example 4

### Milk Protein Systems

### Example 4.1

### Milk, Pectin & TGase

In acidified milk products, such as yoghurt and acidified dairy desserts, stabilisers, such as pectin, are used for providing improved consistency, for example resulting in a higher viscosity in stirred products and a higher gel strength in set type products. As a model for such a product type we used a chemically acidified milk gel.

In acidified skim milk there was a clear synergy between the use of pectin and enzymatic cross-linking, as shown in FIG. 8 (the values shown are averages of duplicate experiments—error bars indicate the standard deviation). Whereas pectin in itself gave a moderate 10% increase in gel strength at 0.1% level, TGase at 10 U/g enzyme preparation gave about a 50% increase in gel stiffness. However, when the two were used in combination the result was a more than 100% increase in gel stiffness indicating a synergistic effect between pectin and enzymatic cross-linking in this system.

These results are confirmed by large deformation measurements—measurements typically well correlated with sensory perception. Results from back-extrusion on Texture Analyser of acidified milk gels are shown below in FIG. 9.

FIG. 9 shows the effect on gel firmness of acidified skim milk gels of pectin and TGase. The numbers indicate the following experiments:

1: Without any additions

2: 0.1% pectin added before heating the milk at 80° C. for 15 min

3: 0.1% pectin added after heating the milk at 80° C. for 15 min

4: 10 U/g TGase added, after heat treatment of the milk (80° C., 15 min), then incubated for 1 hr at 40° C. before 0. 1% pectin added

5: Pectin and TGase added together, then incubated for 1 hr at 40° C. before heat treatment (80° C., 15 min)

6: Pectin added, then heat treatment (80° C., 15 min), before the addition of TGase and incubation at 40° C. for 1 hr

7: Heat treatment (80° C., 15 min), then cooling to 40° C., before the addition of TGase and incubation for 1 hr at 40° C.

GDL was added as the acidifier to all samples after the various treatments and the samples were incubated at 40° until the pH had dropped to 4.5. Then the samples were cooled and stored overnight at 5° C. before measurement.

For comparison with the results obtained with pectin in combination with a cross-linking enzyme, the effect of increasing the pectin dosage is shown in FIG. 10. FIG. 10 shows the effect on gel firmness of acidified skim milk gels of increasing the dosage of pectin. No benefit is found on the firmness and furthermore the gels become gritty at high pectin dosages (as observed visually). It is clear that increased gel firmness can not be obtained by increasing the pectin dosage.

The synergy between pectin and TGase in the yoghurt model system became much more obvious, when the dosage of pectin was increased to 0.2%—see FIG. 11. FIG. 11 shows the effect on gel firmness of acidified skim milk gels of different combinations of pectin and TGase dosages. Concentrations are as indicated on the graph. Samples were all prepared as sample 4 in FIG. 9. Added alone 0.2% pectin decreased the gel firmness (see FIG. 10), however with TGase a strong synergy was found when combining 0.2% pectin with as little as 2.5 U/g TGase.

### Example 4.2

### Milk, Starch & TGase

Experiments were performed with starch instead of pectin—in this system a weak rather than a strong synergy was found—see FIG. 12.

The numbers in FIG. 12 indicate the following experiments:

1: Without any additions

2: 0.5% starch added before heating of the milk at 80° C. for 15 min

3: 0.5% starch added after heating of the milk at 80° C. for 15 min

4: 10 U/g TGase added after heat treatment of the milk (80° C., 15 min), then incubated 1 hr at 40° C. before 0.5% starch added

5: starch and TGase added together, then incubated for 1 hr at 40° C. before heat treatment (80° C., 15 min)

6: starch added, then heat treatment (80° C., 15 min), before the addition of TGase and incubation for 1 hr at 40° C.

7: Heat treatment (80° C., 15 min), then cooling to 40° C., before the addition of TGase and incubation for 1 hr at 40° C.

GDL was added as the acidifier to all samples after the various treatments and the samples were incubated at 40° until pH had dropped to 4.5. Then samples were cooled and stored overnight at 5° C. before measurement.

The results (FIG. 12) show that starch on its own gives a small increase in firmness, whereas the combination of starch and TGase results in higher firmness. TGase alone also gives significant increase in firmness and the combined effect of starch and TGase seems only slightly more than additive, and there is only a beneficial effect of adding both when starch is added (i.e. gelatinised) before TGase is.

### Example 5

### Soy Protein Systems

In soy based acidified gels the synergy between pectin and TGase was less obvious than in the milk based system. However the gels were very firm due to the high protein content and this may have affected the ability to differentiate between the samples containing TGase alone and those containing pectin as well. However a slight synergy may be seen in FIG. 13.

The synergy becomes much more clear, as shown in FIG. 14, when the level of pectin was increased to 0.2%. FIG. 14 shows the effect of pectin and TGase on gel firmness of acidified soy protein gels. The samples were prepared as described in FIG. 12. The gel with TGase and 0.2% pectin was prepared as sample 4 in FIG. 12. Pectin alone at a dosage of 0.2% did not increase the gel firmness, however together with TGase a gel much firmer than with just TGase was formed.

FIG. 13 shows the effect of pectin and TGase on gel firmness of acidified soy protein gels. The numbers indicate the following experiments:

1: Without any additions

2: 0.1% pectin added before heating of the soy solution at 80° C. for 15 min

3: 0.1% pectin added after heating of the soy solution at 80° C. for 15 min

4: 10 U/g TGase added, after heat treatment of the soy solution (80° C., 15 min), then incubated for 1 hr at 40° C. before 0.1% pectin added

5: Pectin and TGase added together, incubated for 1 hr at 40° C., before heat treatment (80° C., 15 min)

6: Pectin added, then heat treatment (80° C., 15 min), before the addition of TGase and incubation at 40° C. for 1 hr

7: Heat treatment (80° C., 15 min), then cooling to 40° C., before the addition of TGase and incubation for 1 hr at 40° C.

GDL was added as the acidifier to all samples after the various treatments and the samples were incubated at 40° until pH had dropped to 4.5. Then samples were cooled and stored overnight at 5° C. before measurement.

### Example 6

### Protein-Containing Beverage Model—Cocoa Milk Systems

Cocoa milk is often stabilised with carrageenan to avoid sedimentation of the cocoa particles during storage. It was investigated whether a synergistic stabilising effect could be found between carrageenan and a cross-linking enzyme in such a drink.

Experiments were performed measuring the sedimentation of a protein-containing beverage containing cocoa solids, carrageenan and TGase. The experiments performed were:

1: Control

2: 10 U/g TGase only

3: 0.04% carrageenan only

4: 0.04% carrageenan and 10 U/g TGase.

5: 0.03% carrageenan only

6: 0.01% carrageenan only

7: 0.01% carrageenan and 1.3 U/g TGase

8. 1.3 U/g TGase

9. Control

At a typically used carrageenan concentration of 0.04%, an addition of 10 U/g TGase decreased the stability compared to the sample where only carrageenan was added as shown in FIG. 15. FIG. 15 shows sedimentation measured as increase in light-scattering at the bottom of the sample. Dosage of carrageenan and TGase indicated. Carrageenan was added before TGase in the mixed sample. Each curve represents three measurements. When added alone at 10 U/g TGase did not increase the stability of the drink, whereas 0.04% carrageenan fully stabilised the cocoa milk compared to the control. The destabilising effect of the two stabilisers, when used in combination at this dosage indicates possible phase separation due to the formation of a too strong network in the cocoa milk (micro syneresis).

However, when the carrageenan concentration was lowered to 0.01% the addition of the cross-linking enzyme in a low dosage clearly improved the stability of the product. FIG. 16 shows sedimentation measured as increase in light scattering at the bottom of the sample. Dosage of carrageenan and TGase indicated on the graph. Carrageenan was added before TGase in the mixed sample. Each curve represents three measurements. As shown in FIG. 16, the stability of the drink was clearly improved compared to when using either of the ingredients alone. This indicates a synergy between the two ingredients in this product.

### Example 7

### Ice Cream Model

Experiments were performed measuring the melt down of ice-cream containing carrageenan and TGase.

The experiments performed were:

1: 0.6% CREMODAN® SE 30 (Standard)

2: 0.6% CREMODAN® SE 30+6.25 U/g TGase

3: 0.3% CREMODAN® Super+0.05% GRINDSTED® Carrageenan

4: 0.3% CREMODAN® Super+0.05% GRINDSTED® Carrageenan +6.25 U/g TGase

5: 0.3% CREMODAN® Super

6: 0.3% CREMODAN® Super+6.25 U/g TGase

The graph (FIG. 17) shows the melt down at 20° C. of the 6 ice creams described above. Ice creams 1 and 2 are standard ice creams made with the full emulsifier-stabiliser complex (monoglycerides, carrageenan, guar, LBG, alginate) and adding TGase to ice cream 2. Clearly ice cream 2 melts slower and less than ice cream 1.

Ice creams 3 and 4 are made with emulsifier (CREMODAN® Super) and GRINDSTED® carrageenan (i.e. without other stabilisers); ice cream 4 is with added TGase; again clearly the ice cream with TGase (ice cream 4) melts slower and to a lesser extent.

Ice creams 5 and 6 are made with emulsifier but no stabiliser; ice cream 6 is with added TGase. The melting is apparently not decreased using TGase.

Thus there is a clear synergy between added hydrocolloid (either the full emulsifier complex or carrageenan without other stabilisers) and TGase.

### Example 8

### Dough System

Experiments were performed measuring the stability and extensibility of a dough containing guar gum and TGase.

The experiments performed were:

1. No added guar gum or TGase

2. 0.95% guar gum

3. 150 U/kg flour TGase

4. 150 U/kg flour TGase and 0.95% guar gum

5. 300 U/Kg flour TGase

6. 300 U/Kg flour TGase and 0.95% guar gum

Dough with each different treatment was made in triplicate.

In the initial experiments, doughs with different additions of TGase and guar were made in order to calculate the water absorption. These doughs were then made on the Farinograph and analysed on the Kieffer Rig according to the method described above. The results from the Farinograph tests are shown in Table 1.

TABLE 1
Farinograph tests

| | Tgase | Guar | Farinograph | Development | Stability |
|---|---|---|---|---|---|
| Day | ppm | % | Water absorb. | time, min | min |
| 1 | 0 | 0 | 54.2 | 1 | 2.7 |
| 1 | 0 | 0.95 | 55.3 | 1.2 | 1.4 |
| 1 | 1500 | 0 | 54.7 | 1.5 | 3.6 |
| 1 | 1500 | 0.95 | 55.5 | 1 | 1.8 |
| 1 | 3000 | 0 | 55.5 | 1.4 | 2.9 |
| 1 | 3000 | 0.95 | 56 | 1.4 | 1.5 |
| 2 | 0 | 0.95 | 55.3 | 1.3 | 1.5 |
| 2 | 1500 | 0.95 | 55.5 | 0.9 | 0.8 |
| 2 | 3000 | 0 | 55.5 | 1.2 | 2.2 |
| 2 | 3000 | 0.95 | 56 | 2.2 | 2.8 |
| 3 | 0 | 0 | 54 | 1.2 | 2.8 |
| 3 | 0 | 0.95 | 55.3 | 1 | 1.5 |
| 3 | 1500 | 0 | 54.5 | 1 | 5.1 |
| 3 | 1500 | 0.95 | 55.5 | 1.4 | 2.1 |
| 3 | 3000 | 0 | 55.5 | 1.3 | 2.8 |

A multifactor ANOVA test showed no significant effect of guar and TGase on the dough development time. The ANOVA analyses of dough stability are shown graphically in FIG. 18. The results indicate that there is an interaction effect between guar and TGase on dough stability.

The results illustrated in FIG. 18 indicate that a low dosage of TGase contributes to improved stability but high dosage of TGase decreases the stability. Adding 0.95% guar gum decreases the stability of the dough but the addition of TGase in combination with guar restores some of the stability.

The results from the Kieffer Rig analysis are shown in Table 2 and the average extensibility curves are shown in FIG. 19

TABLE 2

| TGase | Guar | Force | Distance | Area |
|---|---|---|---|---|
| ppm | % | g | mm | g × mm |
| 0 | 0 | 25.423 | 111.962 | 1727.59 |
| 0 | 0.95 | 28.324 | 95.629 | 1631.01 |
| 1500 | 0 | 29.188 | 99.394 | 1598.21 |
| 1500 | 0.95 | 32.516 | 83.017 | 1760.34 |
| 3000 | 0 | 30.735 | 90.216 | 1650.88 |
| 3000 | 0.95 | 38.962 | 75.933 | 1837.04 |
| 0 | 0.95 | 27.448 | 86.12 | 1623.49 |
| 1500 | 0.95 | 27.835 | 87.485 | 1600.06 |
| 3000 | 0 | 28.841 | 87.325 | 1502.47 |
| 3000 | 0.95 | 40.894 | 74.826 | 1852.1 |
| 0 | 0 | 25.677 | 98.77 | 1628.25 |
| 0 | 0.95 | 28.635 | 91.831 | 1708.72 |
| 1500 | 0 | 28.506 | 83.892 | 1523.6 |
| 1500 | 0.95 | 31.468 | 91.024 | 1823.53 |
| 3000 | 0 | 25.468 | 84.996 | 1327.05 |

The effects of TGase and guar on Force was evaluated by an ANOVA test shown in FIG. 20. The results indicate a strong interaction between guar and TGase on the maximum force needed to pull the dough in the Kieffer Rig.

The effect of guar and TGase on the distance in mm, before the dough break in the Kieffer test is illustrated in FIG. 21. Both guar and TGase reduced the distance before the dough broke, but the ANOVA indicated no interaction effects.

The effects of guar and TGase on the area below the extensibility curve is a measure for the total work input needed to pull the dough strip. The ANOVA evaluation of the effects on Area are illustrated in FIG. 22. The ANOVA results indicate an interaction between guar and TGase, and it is very interesting to notice (FIG. 22) that TGase alone decreases the Area-value and guar alone has no effect on Area-value, but in combinantion there is a significant increase in Area-value. This effect should be predicted as an inprovement in dough stability when used in baking.

TGase and guar was tested in the model system by making dough based on 10 g flour in a mini Farinograph. Extensibility of these doughs was tested in a Texture Analyser using a Kieffer Rig. The results have confirmed that there are synergistic effects of adding guar and TGase in combinations to a dough. This was clearly illustrated by the effects on the increase in maximum force needed to pull the dough and also a synergistic increased effect is observed on the energy needed to pull the dough until it breaks.

### Example 9

### Low Fat Spread

Materials and Methods (Low Fat Spread)

Low fat spread model—A low fat spread was prepared by the basic recipe below:

| Water Phase | | Fat Phase | |
|---|---|---|---|
| Water | 55.6 | Hydrogenated Soya oil | 9.9 |
| | | (mp 41° C.) | |
| Salt (NaCl) | 1.2 | Rapeseed oil | 29.6 |
| Skimmed milk powder | 1 | Dimodan | 0.5 |
| | | (Monoglyceride) | |
| Alginate | 1.5 | Beta carotene | 4 ppm |
| TGase | 0.57 | | |
| Potassium sorbate | 0.1 | | |
| EDTA | 0.015 | | |
| Water Phase Total | 60% | Fat Phase Total | 40% |

In some experiments some or all of the alginate was substituted with water.

In some experiments TGase was substituted with water.

All components of the water phase except TGase were mixed and dissolved at 60° C. and then cooled 37° C. TGase was added and the whole water phase was incubated 1.5 h.

The fat phase was mixed at 65° C. and cooled to 37° C.

The two phases were mixed and homogenised in by vigorous stirring. The spread was crystallised and knead in a tube chiller. After processing the samples were filled in 100 ml containers and left to settle at 4° C. for 14 days before visual and organoleptic evaluation.

The experiments performed were:

A: 1.5% alginate 0% TGase

B: 0.5% alginate 0% TGase

C: 0% alginate 0% TGase

D: 1.5% alginate 0.57% TGase

E: 0.5% alginate 0.57% TGase

F: 0% alginate 0.57% TGase

Any component omitted compared to the basic recipe in the material and methods section was substituted with water.

Evaluation:

The samples were evaluated by an expert panel and given scores from 0 to 8 on each parameter evaluated. Syneresis was evaluated by visual perception. Stability was evaluated by visual perception after spreading the low fat spread on cardboard. A stable spread is one that retains a smooth texture when spread i.e. it does not become particulate. Stickiness was evaluated organoleptically.

TABLE 3

| | Syneresis (visual | | Stickiness |
|---|---|---|---|
| | perception) | Stability (visual perception) | (mouthfeel) |
| | 0 = low; 8 = high | 0 = smooth; 8 = particulate | 0 = low; 8 = high |
| A | 0 | 3 | 8 |
| B | 2 | 4 | 6 |
| C | 8 | 8 | — |
| D | 0 | 0 | 3 |
| E | 0 | 1 | 0 |
| F | 8 | 8 | — |

It can be concluded that by combining TGase and alginate the amount of alginate can be reduced by at least ⅔ without getting more syneresis. Low stickiness, high stability and low syneresis could only be achieved by combining alginate and TGase, which illustrates the synergistic effect of the two components. Only the samples containing both alginate and TGase were texturally and visually acceptable products.

### Example 10

### Processed Cheese

Materials and Methods

Processed Cheese Model

Processed cheese was prepared by the basic recipe below:

| Water Phase | % (w/w) |
|---|---|
| Water | 36.1 |
| Processed cheese | 45.26 |
| Joha S9 | 2.50 |
| (Alginate) FD150 | 1.00 |
| Calcium lactate | 0.31 |
| Lactic Acid | 0.20 |
| Flavour 4723 | 2.00 |
| Salt NaCl | 0.40 |
| Dimodan OT | |
| Rapeseed oil | 8.76 |
| Starch 570 | |
| Skimmed milk powder | 3.00 |
| Tgase | 0.5 |

Raw Cheese, salts, calcium lactate, oil, flavour and enzyme was mixed with ⅔ of the water in a limitech mixer at 40° C. and incubated at this temperature for 1 h. The alginate was dissolved in the rest of the water at 75° C. and mixed with the cheese mass. The whole mix was heated to 95° C. for 7 min. The pH of the mix was adjusted to 5.6 with lactic acid before tapping the mix into 100 ml plastic containers.

The experiments performed were

A: 0% alginate, 0% TGase

B: 0.5% alginate, 0% TGase

C: 1% alginate, 0% TGase

D: 0% alginate, 0.5% TGase

E: 0.5% alginate, 0.5% TGase

F: 1% alginate, 0.5% TGase

Evaluation

The samples were evaluated visually and by texture analysis.

A picture showing samples of the cheeses C, D, and F is shown in FIG. 23.

The synergistic effect of alginate and TGase treatment is immediately visible since only when the two compounds are combined do we get a firm and solid texture.

Further more the cheese samples were evaluated by texture analysis. The results of the breaking strength of the samples are shown in Table 4

TABLE 4
Breaking strength of processed cheese samples

| | Breaking strength |
|---|---|
| Sample | (g/cm²) |
| A | 16 |
| B | 15 |
| C | 18 |
| D | 42 |
| E | 528 |
| F | 652 |

The synergy effects are clearly seen by the results in tab. X since only the samples containing both alginate and TGase have a high breaking strength. The effect on the cheeses containing both alginate and TGase cannot be explained by a sum of the effect of TGase and alginate individually.

### Example 11

### Cream Cheese

Materials and Methods

Cream Cheese Model

Cream cheese was prepared by the basic recipe below:

| | % (w/w) |
|---|---|
| Water | 11 |
| Cream Cheese BASE 70+ | 40 |
| Quark | 47 |
| Alginate | 0.2 |
| TGase | 1.0 |
| Nisaplin ™ | 0.017 |
| NaCl | 0.5 |
| TOTAL | 100 |

In some experiments some or all of the alginate was substituted with water.

In some experiments TGase was substituted with water.

Cream cheese base and quark was mixed with water at 40° C. The TGase was added and the cheese mass was left to incubate at 40° C. for 30 min. Alginate, salt and Nisaplin™ was mixed and added to the cheese mass. The cheese mass was heated at 80° C. for 3 min, then cooled to 70° C. and filled into 100 ml plastic containers. The cheese was stored at 5° C. for 5 days before evaluation.

The experiments performed were

A: 0.2% alginate 0% TGase

B: 0. 1% alginate 0% TGase

C: 0% alginate 0% TGase

D: 0.2% alginate 1% TGase

E: 0.1% alginate 1% TGase

F: 0% alginate 1% TGase

Any component omitted compared to the basic recipe in the material and methods section was substituted with water

Evaluation

The samples were evaluated by an expert panel and given scores from 0 to 8 on each parameter evaluated. Syneresis was evaluated by visual perception. Stability was evaluated by visual perception after spreading the cheese on cardboard. A stable cheese is one that retains a smooth texture when spread i.e. it does not become particulate.

TABLE 5

| | Syneresis (visual perception) | Stability (visual perception) |
|---|---|---|
| | 0 = low; 8 = high | 0 = smooth; 8 = particulate |
| A | 2 | 3 |
| B | 4 | 5 |
| C | 8 | 8 |
| D | 0 | 0 |
| E | 1 | 2 |
| F | 8 | 8 |

It is seen from Table 5 that low syneresis and high stability could only be achieved by combining alginate and TGase. Only the sample containing both alginate and TGase was a texturally and visually acceptable product.

Conclusions

The synergistic formation of a gel was demonstrated in a wide range of systems. Particularly interesting synergistic effects were found for:

Carrageenan and a cross-linking enzyme on the gel strength of soy based dessert creams.

Carrageenan and a cross-linking enzyme on the gel strength of whey based dessert creams.

Pectin and a cross-linking enzyme on the gel strength of acidified milk/soy protein gels.

Carrageenan and a cross-linking enzyme on the stability of a protein containing beverage comprising cocoa solids

Carrageenan and a cross-linking enzyme on the melt down of ice cream

Guar gum and a cross-linking enzyme on the stability and extensibility of dough

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as paragraphed should not be unduly limited to such specific embodiments. Indeed, various modifications of the described modes for carrying out the invention which are obvious to those skilled in chemistry or related fields are intended to be within the scope of the following paragraphs.

The invention will now be further described by the following numbered paragraphs:

1. A composition comprising a hydrocolloid, and an enzyme, wherein the enzyme is a cross-linking enzyme and the hydrocolloid and enzyme are present in an amount to provide a dosage of the enzyme in a protein containing foodstuff of no greater than 20 U/g and a concentration of the hydrocolloid in the foodstuff of less than 1%.

2. A composition comprising a hydrocolloid, a protein and an enzyme, wherein the enzyme is a cross-linking enzyme and the dosage of the enzyme is no greater than 20 U/g of protein and the concentration of hydrocolloid is less than 1%.

3. A composition according to paragraph 1 or 2 wherein the hydrocolloid is selected from carrageenan, starch, pectin, alginate, locust bean gum, gellan, xanthan, carboxy-methyl-cellulose, guar gum, acacia gum and combinations thereof.

4. A composition according to paragraph 1, 2 or 3 wherein the enzyme is TGase.

5. A composition according to any one of paragraphs 1 to 4 wherein the composition further comprises soy protein.

6. A composition according to paragraph 5 wherein the hydrocolloid is carrageenan, preferably in a concentration of no greater than 0.5%.

7. A composition according to paragraph 5 wherein the hydrocolloid is starch.

8. A composition according to paragraph 5 wherein the hydrocolloid is pectin.

9. A composition according to paragraph 8 wherein the level of pectin is no greater than 0.3%.

10. A composition according to any one of paragraphs 1 to 4 wherein the composition further comprises milk protein.

11. A composition according to paragraph 10 wherein the hydrocolloid is carrageenan.

12. A composition according to paragraph 11 wherein the composition additionally comprises an emulsifier-stabiliser complex.

13. A composition according to paragraph 10 wherein the hydrocolloid is starch.

14. A composition according to paragraph 10 wherein the hydrocolloid is pectin.

15. A composition according to paragraphs 14 wherein the concentration of pectin is no greater than 0.3% and the concentration of the enzyme is no greater than 20 U/g.

16. A composition according to any one of paragraphs 1 to 4 wherein the composition further comprises whey protein.

17. A composition according to paragraph 16 wherein the hydrocolloid is carrageenan.

18. A composition according to paragraph 17 wherein the hydrocolloid is starch.

19. A protein-containing beverage comprising a composition according to any one of paragraphs 1 to 4 and a milk protein.

20. A protein-containing beverage according to paragraph 19 wherein the hydrocolloid is carrageenan.

21. A protein-containing beverage according to paragraph 20 wherein the concentration of carrageenan is no greater than 0.02% and the dosage of enzyme is no greater than 2 U/g.

22. A protein-containing beverage according to paragraphs 19 to 21, which further comprises a flavouring wherein the flavouring is cocoa solids.

23. A protein-containing beverage according to paragraphs 19 to 21, which further comprises a flavouring wherein the flavouring is selected from chocolate, strawberry, raspberry, banana, orange, mango, lemon, lime, cherry, peach, pear, apple, pineapple or

34. A process according to paragraph 27, 28 or 29 wherein the protein is milk protein, the hydrocolloid is pectin and the enzyme is contacted with the milk protein before the pectin is contacted with the milk protein.

35. A process according to paragraph 27, 28 or 29 wherein the protein is whey protein, the hydrocolloid is starch and the enzyme is contacted with the whey milk protein before the starch is contacted with the whey protein.

36. A process according to paragraph 27, 28 or 29 wherein the protein is milk protein, the hydrocolloid is carrageenan and the carrageenan is contacted with the milk protein before the enzyme is contacted with the milk protein.

37. A process according to paragraph 27, 28 or 29 wherein the protein is gluten, the hydrocolloid is guar gum and the guar gum and enzyme are contacted with the gluten simultaneously.

38. A process according to paragraph 27 wherein the hydrocolloid and the enzyme are provided as a composition according to any one of paragraphs 1 to 26.

39. Use of a hydrocolloid and a cross-linking enzyme for the synergistic formation of a gel in a protein containing foodstuff.

40. Use according to paragraph 39 wherein the hydrocolloid and cross-linking are provided by a composition according to any of paragraphs 1 to 26.

41. Use of a composition comprising a hydrocolloid, a protein and a cross-linking enzyme in the preparation of foodstuff selected a dessert, an acidified gel, a drinkable protein-containing beverage, and a dough

42. Use of a composition comprising a hydrocolloid, and a cross-linking enzyme in the preparation of a protein containing ice cream wherein said enzyme is in a dosage no greater than 20 U/g.

43. Use according to paragraph 42 wherein the hydrocolloid is carrageenan and the enzyme is TGase.

44. A composition as substantially hereinbefore described with reference to Example 1, 2, 3, 4, 5, 6, 7, or 8.

45. A process as substantially hereinbefore described with reference to Example 1, 2, 3, 4, 5, 6, 7, or 8.

46. A use as substantially hereinbefore described with reference to Example 1, 2, 3, 4, 5, 6, 7, or 8.
